(19) United States
(12) Patent Application Publication
(10) Pub. No.: US 2014/0119873 A1
(43) Pub. Date: May 1, 2014

(54) Device for Transporting Cassette

(71) Applicant: SHENZHEN CHINA STAR OPTOELECTRONICS TECHNOLOGY CO. LTD., Shenzhen, Guangdong (CN)

(72) Inventors: Zenghong Chen, Shenzhen City (CN); Chunhao Wu, Shenzhen City (CN); Kunhsien Lin, Shenzhen City (CN); Minghu Qi, Shenzhen City (CN); Zhenhua Guo, Shenzhen City (CN); Weibing Yang, Shenzhen City (CN)

(73) Assignee: Shenzhen China Star Optoelectronics Technology Co., Ltd., Shenzhen, Guangdong (CN)

(21) Appl. No.: 13/701,538

(22) PCT Filed: Nov. 15, 2012
(86) PCT No.: PCT/CN2012/084711

§ 371 Date: Dec. 3, 2012

(30) Foreign Application Priority Data
Oct. 31, 2012 (CN) CN 201210426617.0

(51) Int. Cl. B65G 49/06

(52) U.S. Cl. CPC B65G 49/06
USPC 414/749.1; 414/800

(57) ABSTRACT

The present invention provides a device for transporting cassette which is used to transport cassette among a crane in a stocker, a load port, and an unload port. A transport port zone is provided at the front-ends of the load port and the unload port, and a horizontal transport mechanism and a vertical transport mechanism are provided at the transport port zone, which transports the empty cassette from the load port to the predetermined unload port. The present invention further provides a corresponding method for transporting cassette. According to the embodiment of the present invention, it can reduce the transporting amount of the crane in the stocker, which effectively solves the bottleneck of excessive transportation of the crane in the stocker and increases the capacity.

This application claims priority to Chinese Patent Application Serial No. 201210426617.0, named as “device for transporting cassette”, filed on Oct. 31, 2012, the specification of which is incorporated herein by reference.

### BACKGROUND OF THE INVENTION

1. Field of the Invention

The present invention relates to a liquid crystal panel production technology, and in particular to a device and a method for transporting cassette.

2. The Related Arts

In the LCD panel manufacturing industry, the glass substrates are stored in the cassette (CST), and the CST is stored in various stockers. All stockers plus the corresponding conveyer (such as crane) and the control device constitute an automated material handling system (AMHS). Each CST in the stocker is transported to each equipment (EQ) by crane to complete the appropriate process. As shown in FIG. 1, it is a schematic view illustrating an automated material handling system, which illustrates two rows of stocker 1, at least one cassette 2 is stored in each stocker 1, the cassette 2 is transported to load port 41 by the crane, each load port 41 is corresponding to the conveyer 5 (CV), the transport device 5 is connected with the equipment (EQ), and unload port 40 is provided next to the load port 41.

FIG. 2 is a schematic view illustrating a known automated stocker transport system transporting cassettes.

First, the crane in the stocker transports the first cassette CST1 and the second cassette CST2 with glass substrates to the load port 1 and the load port 2 respectively; the glass substrates are respectively removed from the CST1 and CST2 by the separator at the load port and then transported out of the load port 1 and the load port 2 respectively through the conveyer (CV) to the equipment (EQ) to complete the corresponding process; the glass substrates, which have been completed the corresponding process, have to be transported to the unload port 3 and unload port 4 by the conveyer (CV) and transported to the CST3 and CST4 by the separators at the unload port 3 and unload port 4. Before this, the empty CST3 and CST4 have to be transported to the unload port 3 and unload port 4 by the crane. After the CST1 and CST2 remove the glass substrates and become the empty cassettes, the CST1 and CST2 have to be transported to the unload port 3 and unload port 4 by the crane, which is used to store the next batch of the glass substrates.

It can be seen in this process that the crane needs to transport twice in each glass transfer process. The first transportation is to transport the CST to the load port, and the second transportation is to transport the empty CST to the unload port. There are a lot of load ports and unload ports in the stocker, which results the excessive transportation of the crane. When it exceeds maximum transporting amount, the CST will be stuck and not be transported, which decreases the capacity.

### SUMMARY OF THE INVENTION

To solve the technical issue in the known technology, the present invention provides a device and a method for transporting cassette, which can decrease the transporting times of the crane and increase the capacity.

To solve the technical issue mentioned above, the present invention provides: a device for transporting cassette, which is used to transport cassette among a crane in a stocker, a load port, and an unload port, comprising: a transport port zone provided at the front-ends of the load port and the unload port, the transport port zone comprising at least two rows of transport ports, wherein the number of each row of transport ports is corresponding to the total number of the load port and the unload port; a horizontal transport mechanism provided on each row of the transport ports, which is used to horizontally transport the cassette among the row of the transport ports; a vertical transport mechanism provided between the adjacent rows of transport ports, which is used to vertically transport the cassette between the adjacent rows of the transport ports; a control device used to control the vertical transport mechanism or/and the horizontal transport mechanism, which transports a cassette with glass substrates from the crane to the load port, or transports an empty cassette from the load port to a predetermined unload port, or transports the cassette with glass substrates from the unload port to the crane.

Wherein, at least one transport port at the front-ends of the unload port is provided as a cassette buffer zone, which is used to receive the empty cassette from the load port when there are cassettes at the predetermined unload port.

Wherein, detecting sensors are provided at the load port, unload port, and the cassette buffer zone, which is used to detect if there are cassettes.

Wherein, the control device is further used to control the vertical transport mechanism or/and the horizontal transport mechanism to transport the empty cassette from the cassette buffer zone to the predetermined unload port after the detecting sensors detect the cassette at the predetermined unload port is removed.

Wherein, it further comprises: a storage device used to store a pre-designed route, the pre-designed route comprises the lines of transporting the cassette with glass substrates to the load port, transporting the empty cassette from the load port to the predetermined unload port, transporting the empty cassette from the load port to the cassette buffer zone, transporting the empty cassette from the cassette buffer zone to the predetermined unload port, and transporting the cassette from the unload port to the crane; the control device drives the vertical transport mechanism or/and the horizontal transport mechanism to transport the cassette or the empty cassette according to the pre-designed route stored in the storage device.

Correspondingly, the another embodiment according to the present invention provides a method for transporting cassette, which comprises the following steps of: transporting a cassette with glass substrates from a crane to a load port through a vertical transport mechanism; transporting an empty cassette to a predetermined unload port through the vertical transport mechanism or/and a horizontal transport mechanism after glass substrates are removed from the cassette by a separator.

Wherein, it further comprises: transporting the cassette with glass substrates to the crane through the vertical transport mechanism or/and the horizontal transport mechanism after glass substrates are reinserted into the empty cassette at the unload port by the separator.

Wherein, the step of transporting the empty cassette to the predetermined unload port further comprises: detecting if there is cassette at the predetermined unload port or not; if there is cassette at the predetermined unload port, transport the empty cassette to a cassette buffer zone, and then transport the empty cassette from the cassette buffer zone to the predetermined unload port after detecting the cassette is removed from the predetermined unload port; otherwise, directly transport the empty cassette to the predetermined unload port.

Wherein, the specific step of transporting the empty cassette to the predetermined unload port is: pre-designing the routes of transporting the empty cassette from the load port to the predetermined unload port, transporting the empty cassette from the load port to the cassette buffer zone, and transporting the empty cassette from the cassette buffer zone to the predetermined unload port; driving the vertical transport mechanism or/and the horizontal transport mechanism to transport the empty cassette to the predetermined unload port according to the pre-designed route.

Wherein, the specific step of transporting the cassette with glass substrates to the crane is: pre-designing the route of transporting the cassette from the unload port to the crane; driving the vertical transport mechanism or/and the horizontal transport mechanism to transport the cassette to the crane according to the pre-designed route.

The embodiment according to the present invention has the beneficial effects as follow:
the crane is not needed to transport the empty cassette from the load port to the predetermined unload port by using the vertical transport mechanism or/and the horizontal transport mechanism, which reduces the transporting amount of the crane in the stocker and effectively solves the bottleneck of excessive transportation of the crane in the stocker and increases the capacity; transport the empty cassette from the load port to the predetermined unload port by directly using the vertical transport mechanism or/and the horizontal transport mechanism according to the pre-designed route, which improves the transport efficiency;
by providing the cassette buffer zone, the empty cassette can be stored at the cassette buffer zone, which can effectively adjust the transport amount of the cassette, reduce the tact time of transporting the cassette, and then increase the capacity.

### BRIEF DESCRIPTION OF THE DRAWINGS

To make the technical solution of the embodiments according to the present invention clear, a brief description of the drawings that are necessary for the illustration of the embodiments will be given as follows. Apparently, the drawings described below show only example embodiments of the present invention and for those having ordinary skills in the art, other drawings may be easily obtained from these drawings without paying any creative effort.

FIG. 1 is a schematic view illustrating an automated material handling system;

FIG. 2 is a schematic view illustrating a known automated stocker transport system transporting cassettes;

FIG. 3 is a schematic view illustrating a device for transporting cassette according to one embodiment of the present invention;

FIG. 4 is a schematic view illustrating the device for transporting cassette according to one embodiment of the present invention vertically transporting the cassette at the transport port zone;

FIG. 5 is a schematic view illustrating the device for transporting cassette according to one embodiment of the present invention horizontally transporting the cassette at the transport port zone; and

FIG. 6 is a schematic view illustrating the route of transporting the cassette according to a method for transporting cassette of one embodiment of the present invention.

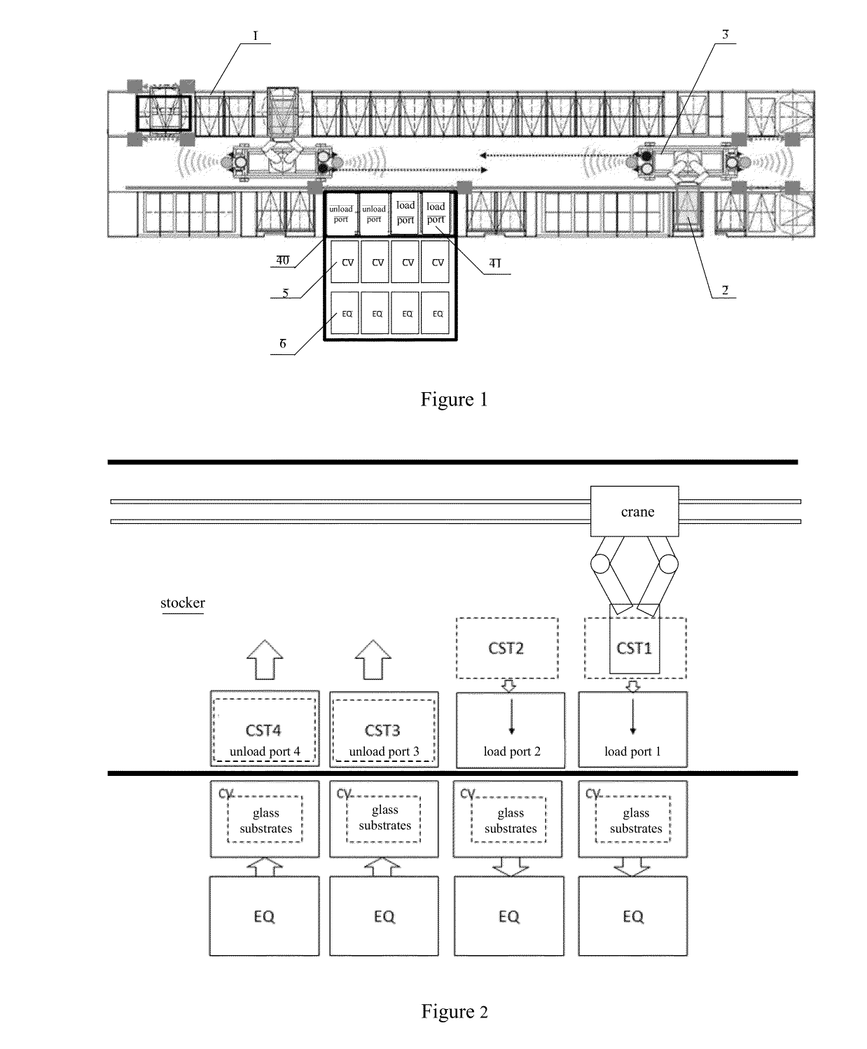

### DETAILED DESCRIPTION OF THE PREFERRED EMBODIMENTS

The detailed descriptions accompanying drawings and the preferred embodiment of the present invention are as follows.

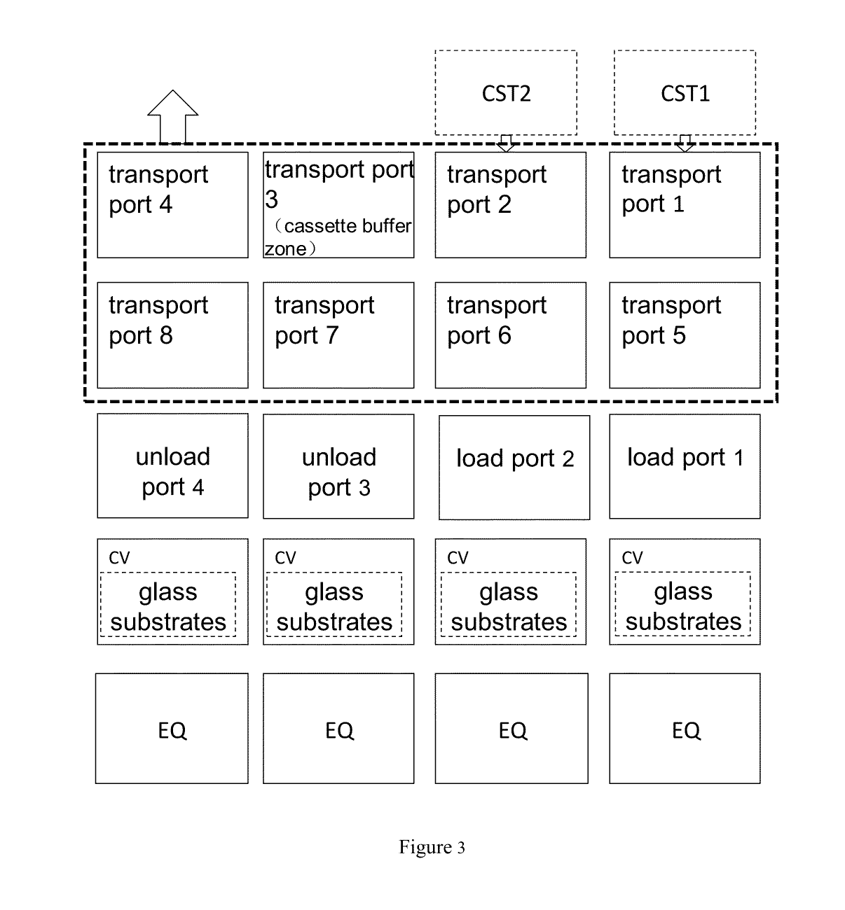

Referring to FIG. 3, it is a schematic view illustrating an automated material handling system.

The device for transporting cassette according to the present invention is used to transport cassette among a crane in a stocker, a load port, and an unload port, which comprises: a transport port zone 7 provided at the front-ends of the load port and the unload port, the transport port zone 7 comprising at least two rows of transport ports, wherein the number of each row of transport ports is corresponding to the total number of the load port and the unload port, and one row of the transport port is adjacent to the load port and the unload port; FIG. 2 shows a transport port zone with two rows, and each row has four transport ports, that is, there are operating port 1 to operating port 4 provided in the first row and operating port 5 to operating port 8 provided in the second row, which is only example to be understood readily; a horizontal transport mechanism provided on each row of the transport ports, which is used to horizontally transport the cassette among the row of the transport ports; a vertical transport mechanism provided between the adjacent rows of transport ports, which is used to vertically transport the cassette between the adjacent rows of the transport ports; a control device used to control the vertical transport mechanism or/and the horizontal transport mechanism, which transports a cassette with glass substrates from the crane to the load port, or transports an empty cassette from the load port to a predetermined unload port, or transports the cassette with glass substrates from the unload port to the crane. In a specific embodiment, the control device can be industrial computer, programmable logic device (PLC), or other devices having control ability.

Wherein, at least one transport port at the front-ends of the unload port is provided as a cassette buffer zone, which is used to receive the empty cassette from the load port when there are cassettes at the predetermined unload port. In FIG. 3, the operating port 3 is provided as the cassette buffer zone. It is understood that multiple operating ports can be provided as the cassette buffer zones if it is necessary. In some embodiments, the cassette buffer zone had better be provided away from the operating ports of the load port and the unload port, that is, there is no cassette buffer zone provided at the operating port adjacent to the load port or the unload port.

Detecting sensors are provided at the load port, unload port, and the cassette buffer zone, which is used to detect if there are cassettes.

The control device is further used to control the vertical transport mechanism or/and the horizontal transport mechanism to transport the empty cassette from the cassette buffer zone to the predetermined unload port after the detecting sensors detect the cassette at the predetermined unload port is removed.

In the device for transporting cassette, it further comprises: a storage device used to store a pre-designed route. The pre-designed route comprises the lines of transporting the cassette with glass substrates to the load port, transporting the empty cassette from the load port to the predetermined unload port, transporting the empty cassette from the load port to the cassette buffer zone, transporting the empty cassette from the cassette buffer zone to the predetermined unload port, and transporting the cassette from the unload port to the crane. The control device drives the vertical transport mechanism or/and the horizontal transport mechanism to transport the cassette or the empty cassette according to the pre-designed route stored in the storage device.

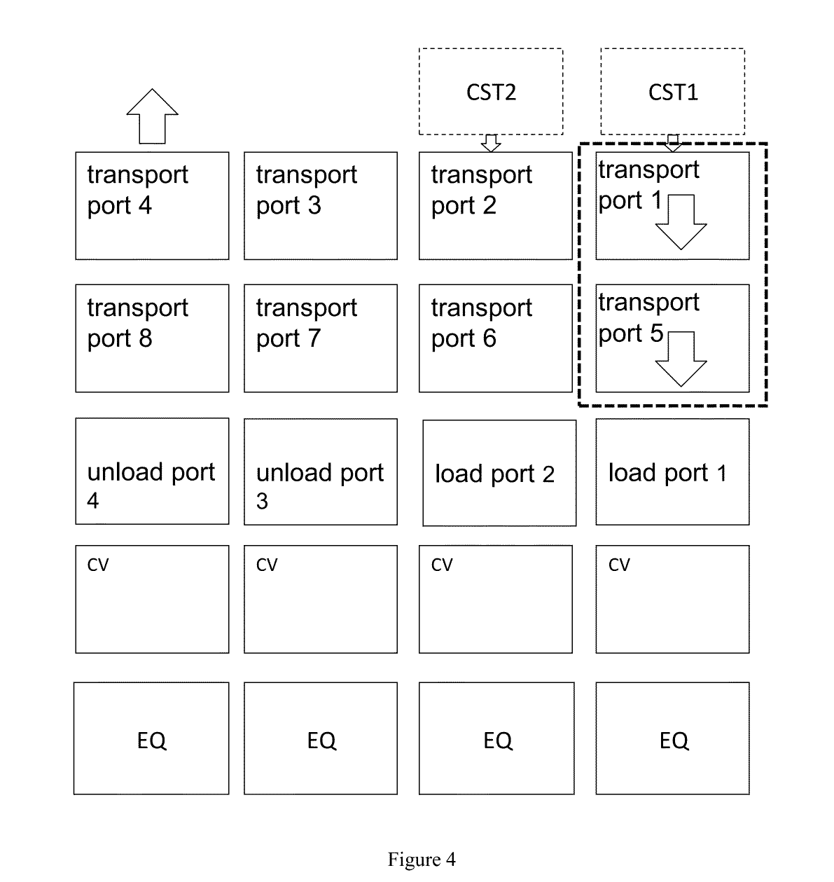

Referring to FIG. 4, it is a schematic view illustrating the device for transporting cassette according to one embodiment of the present invention vertically transporting the cassette at the transport port zone. The cassette can be vertically transported between the adjacent rows of the transport ports through the vertical transport mechanism. In FIG. 4, CST1 is vertically transported from the operating port 1 to the operating port 5, and CST1 can be also vertically transported from the operating port 5 to the operating port 1. Similarly, the cassette can be vertically transported between the operating port 2 and the operating port 6, between the operating port 3 and the operating port 7, and between the operating port 4 and the operating port 8 though the vertical transport mechanism.

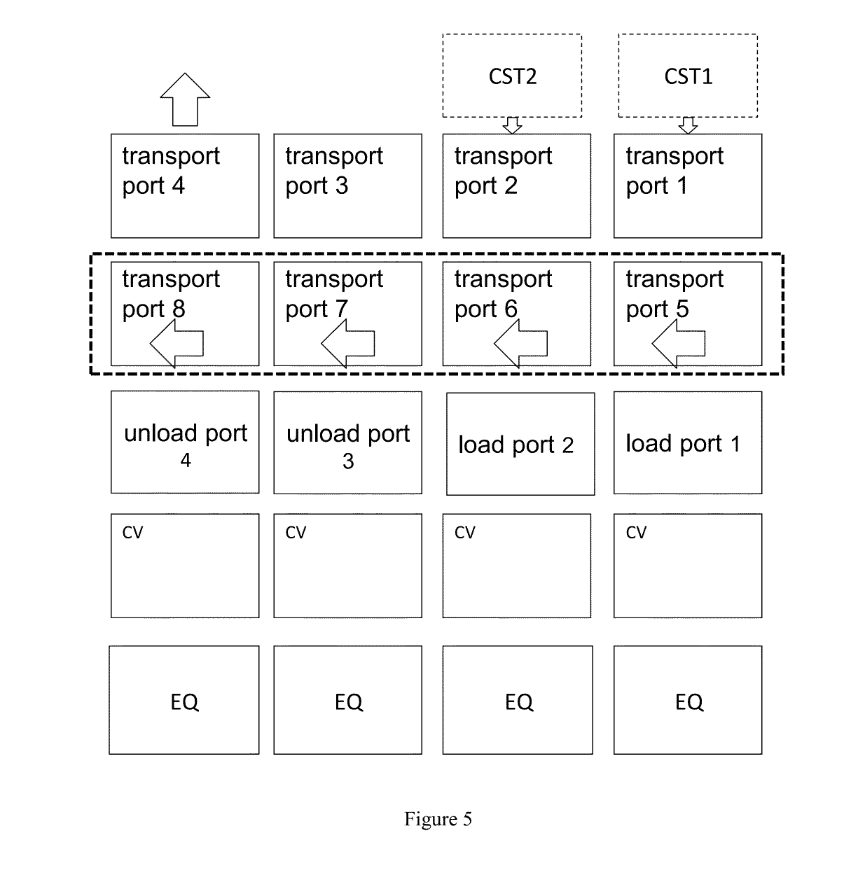

Referring to FIG. 5, it is a schematic view illustrating the device for transporting cassette according to one embodiment of the present invention horizontally transporting the cassette at the transport port zone. The cassette can be horizontally transported among the row of the transport ports through the horizontal transport mechanism. In FIG. 5, the cassette is horizontally transported from the operating port 5 to the operating port 8, and the cassette can be also horizontally transported from the operating port 8 to the operating port 5. Similarly, the cassette can be horizontally transported among the operating port 1, the operating port 2, the operating port 3, and the operating port 4 though the horizontal transport mechanism.

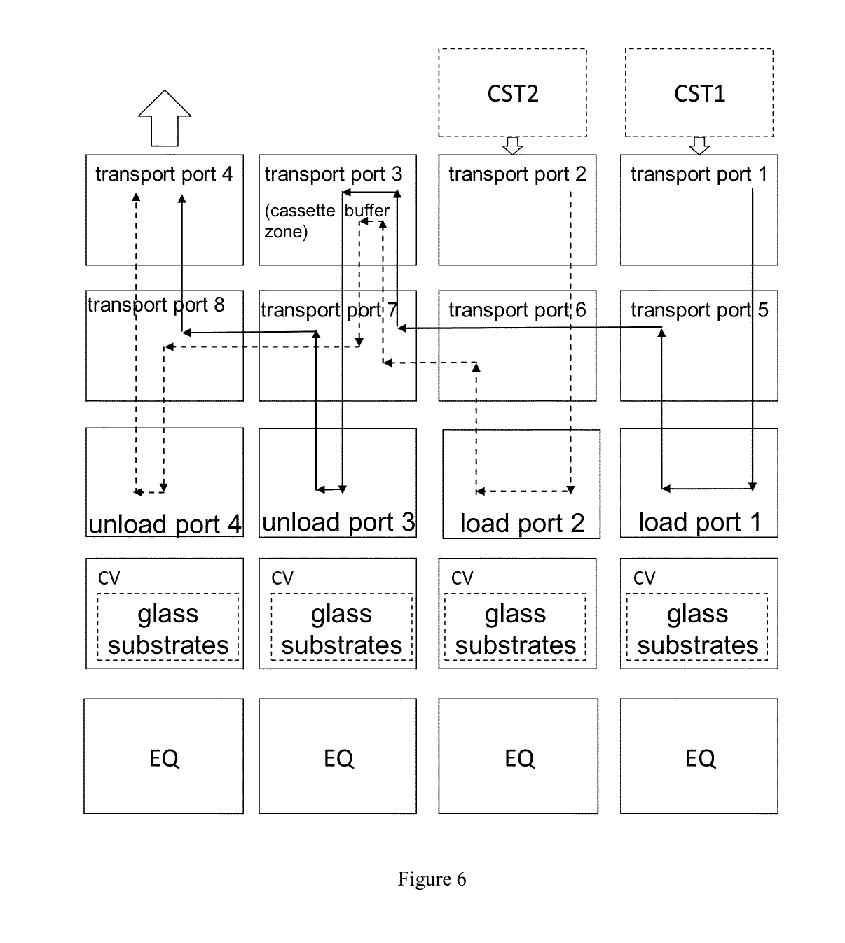

Referring to FIG. 6, it is a schematic view illustrating the route of transporting the cassette according to a method for transporting cassette of one embodiment of the present invention. The detailed schematic flow diagram of the method for transporting cassette according to the present invention is further described as follows.

Wherein, solid line and dashed line represent the transport processes of the first cassette CST1 and the second cassette CST2. To facilitate the description, take the first cassettes CST1 as an example, which is described as follows.

First, the crane in the stocker transports the first cassette CST1 with glass substrates to the transport port 1; transport the first cassette CST1 to the load port 1 through the vertical transport mechanism; transport the empty cassette to the predetermined unload port through the vertical transport mechanism/the horizontal transport mechanism after glass substrates are removed from the first cassette CST1 by a separator. In FIG. 6, the load port corresponding to the first cassette CST1 is load port 3. The process comprises: pre-designing the routes of transporting the empty cassette from the load port to the predetermined unload port, transporting the empty cassette from the load port to the cassette buffer zone, and transporting the empty cassette from the cassette buffer zone to the predetermined unload port; driving the vertical transport mechanism or/and the horizontal transport mechanism to transport the empty cassette to the predetermined unload port according to the pre-designed route.

Specifically, it further comprises: detecting if there is cassette at the predetermined unload port or not; if there is cassette at the predetermined unload port, transport the empty cassette to a cassette buffer zone, and then transport the empty cassette from the cassette buffer zone to the predetermined unload port after detecting the cassette is removed from the predetermined unload port; otherwise, directly transport the empty cassette to the predetermined unload port.

In FIG. 6, the transport port 3 is provided as the cassette buffer zone, and it is detected that there are cassettes temporarily stored at the unload port 3 during transportation. Therefore, the empty cassette, which the glass substrates are removed from the first cassette CST1, is transported to the transport port 5 through the vertical transport mechanism first, then be transported to the transport port 7 through the horizontal transport mechanism, and then be transported to the cassette buffer zone through the vertical transport mechanism. Finally, it is transported to the predetermined unload port 3 after detecting the cassette at the predetermined unload port 3 is removed.

At unload port 3, transport the cassette with glass substrates to the crane through the vertical transport mechanism or/and the horizontal transport mechanism after the treated glass substrates are reinserted into the empty cassette by the separator. Specifically, it is transported to the transport port 7 through the vertical transport mechanism, then be transported to the transport port 8 through the horizontal transport mechanism, then be transported to the transport port 4 through the vertical transport mechanism, and then wait to be transported to the corresponding stocker by the crane.

Similarly, the transportation of the CTS2 refers to the dashed line in FIG. 6. The principle is similar to the transportation of the CTS1 and not repeated.

It can be understood that the transport routes of the CTS1 and the CTS2 are only examples, various routes can be pre-designed for any cassette according to the specific using situation. Specifically, the pre-designed routes can be stored first, and then drive the vertical transport mechanism or the horizontal transport mechanism to control the route to transport the corresponding cassette by the control device (such as industrial computer).

The embodiment according to the present invention has the beneficial effects as follow:
the crane is not needed to transport the empty cassette from the load port to the predetermined unload port by using the vertical transport mechanism or/and the horizontal transport mechanism, which reduces the transporting amount of the crane in the stocker and effectively solves the bottleneck of excessive transportation of the crane in the stocker and increases the capacity; transport the empty cassette from the load port to the predetermined unload port by directly using the vertical transport mechanism or/and the horizontal transport mechanism according to the pre-designed route, which improves the transport efficiency;
by providing the cassette buffer zone, the empty cassette can be stored at the cassette buffer zone, which can effectively adjust the transport amount of the cassette, reduce the tact time of transporting the cassette, and then increase the capacity.

The preferred embodiments according to the present invention are mentioned above, which cannot be used to define the scope of the right of the present invention. Those modifications and variations are considered encompassed in the scope of protection defined by the clams of the present invention.

What is claimed is:

1. A device for transporting cassette, which is used to transport cassette among a crane in a stocker, a load port, and an unload port, comprising:
a transport port zone provided at the front-ends of the load port and the unload port, the transport port zone comprising at least two rows of transport ports, wherein the number of each row of transport ports is corresponding to the total number of the load port and the unload port;
a horizontal transport mechanism provided on each row of the transport ports, which is used to horizontally transport the cassette among the row of the transport ports;
a vertical transport mechanism provided between the adjacent rows of transport ports, which is used to vertically transport the cassette between the adjacent rows of the transport ports;
a control device used to control the vertical transport mechanism or/and the horizontal transport mechanism, which transports a cassette with glass substrates from the crane to the load port, or transports an empty cassette from the load port to a predetermined unload port, or transports the cassette with glass substrates from the unload port to the crane.

2. The device for transporting cassette as claimed in claim 1, wherein at least one transport port at the front-ends of the unload port is provided as a cassette buffer zone, which is used to receive the empty cassette from the load port when there are cassettes at the predetermined unload port.

3. The device for transporting cassette as claimed in claim 2, wherein detecting sensors are provided at the load port, unload port, and the cassette buffer zone, which is used to detect if there are cassettes.

4. The device for transporting cassette as claimed in claim 2, wherein the control device is further used to control the vertical transport mechanism or/and the horizontal transport mechanism to transport the empty cassette from the cassette buffer zone to the predetermined unload port after the detecting sensors detect the cassette at the predetermined unload port is removed.

5. The device for transporting cassette as claimed in claim 2, wherein it further comprises:
a storage device used to store a pre-designed route, the pre-designed route comprises the lines of transporting the cassette with glass substrates to the load port, transporting the empty cassette from the load port to the predetermined unload port, transporting the empty cassette from the load port to the cassette buffer zone, transporting the empty cassette from the cassette buffer zone to the predetermined unload port, and transporting the cassette from the unload port to the crane;
wherein, the control device drives the vertical transport mechanism or/and the horizontal transport mechanism to transport the cassette or the empty cassette according to the pre-designed route stored in the storage device.

6. The device for transporting cassette as claimed in claim 3, wherein it further comprises:
a storage device used to store a pre-designed route, the pre-designed route comprises the lines of transporting the cassette with glass substrates to the load port, transporting the empty cassette from the load port to the predetermined unload port, transporting the empty cassette from the load port to the cassette buffer zone, transporting the empty cassette from the cassette buffer zone to the predetermined unload port, and transporting the cassette from the unload port to the crane;
wherein, the control device drives the vertical transport mechanism or/and horizontal the transport mechanism to transport the cassette or the empty cassette according to the pre-designed route stored in the storage device.

7. The device for transporting cassette as claimed in claim 4, wherein it further comprises:
a storage device used to store a pre-designed route, the pre-designed route comprises the lines of transporting the cassette with glass substrates to the load port, transporting the empty cassette from the load port to the predetermined unload port, transporting the empty cassette from the load port to the cassette buffer zone, transporting the empty cassette from the cassette buffer zone to the predetermined unload port, and transporting the cassette from the unload port to the crane;
wherein, the control device drives the vertical transport mechanism or/and the horizontal transport mechanism to transport the cassette or the empty cassette according to the pre-designed route stored in the storage device.

8. A method for transporting cassette, which comprises the following steps of:
transporting a cassette with glass substrates from a crane to a load port through a vertical transport mechanism;
transporting an empty cassette to a predetermined unload port through the vertical transport mechanism or/and a horizontal transport mechanism after glass substrates are removed from the cassette by a separator.

9. The method for transporting cassette as claimed in claim 8, wherein it further comprises:
transporting the cassette with glass substrates to the crane through the vertical transport mechanism or/and the horizontal transport mechanism after glass substrates are reinserted into the empty cassette at the unload port by the separator.

10. The method for transporting cassette as claimed in claim 9, wherein the step of transporting the empty cassette to the predetermined unload port further comprises:
detecting if there is cassette at the predetermined unload port or not;
if there is cassette at the predetermined unload port, transport the empty cassette to a cassette buffer zone, and then transport the empty cassette from the cassette buffer zone to the predetermined unload port after detecting the cassette is removed from the predetermined unload port;
otherwise, directly transport the empty cassette to the predetermined unload port.

11. The method for transporting cassette as claimed in claim 10, wherein the specific step of transporting the empty cassette to the predetermined unload port is:
pre-designing the routes of transporting the empty cassette from the load port to the predetermined unload port, transporting the empty cassette from the load port to the cassette buffer zone, and transporting the empty cassette from the cassette buffer zone to the predetermined unload port;
driving the vertical transport mechanism or/and the horizontal transport mechanism to transport the empty cassette to the predetermined unload port according to the pre-designed route.

12. The method for transporting cassette as claimed in claim 10, wherein the specific step of transporting the cassette with glass substrates to the crane is:
pre-designing the route of transporting the cassette from the unload port to the crane;
driving the vertical transport mechanism or/and the horizontal transport mechanism to transport the cassette to the crane according to the pre-designed route.

13. A method for transporting cassette, which comprises the following steps of:
transporting a cassette with glass substrates from a crane to a load port through a vertical transport mechanism;
transporting an empty cassette to a predetermined unload port through the vertical transport mechanism or/and a horizontal transport mechanism after glass substrates are removed from the cassette by a separator;
transporting the cassette with glass substrates to the crane through the vertical transport mechanism or/and the horizontal transport mechanism after glass substrates are reinserted into the empty cassette at the unload port by the separator.

14. The method for transporting cassette as claimed in claim 13, wherein the step of transporting the empty cassette to the predetermined unload port further comprises:
detecting if there is cassette at the predetermined unload port or not;
if there is cassette at the predetermined unload port, transport the empty cassette to a cassette buffer zone, and then transport the empty cassette from the cassette buffer zone to the predetermined unload port after detecting the cassette is removed from the predetermined unload port;
otherwise, directly transport the empty cassette to the predetermined unload port.

15. The method for transporting cassette as claimed in claim 14, wherein the specific step of transporting the empty cassette to the predetermined unload port is:
pre-designing the routes of transporting the empty cassette from the load port to the predetermined unload port, transporting the empty cassette from the load port to the cassette buffer zone, and transporting the empty cassette from the cassette buffer zone to the predetermined unload port;
driving the vertical transport mechanism or/and the horizontal transport mechanism to transport the empty cassette to the predetermined unload port according to the pre-designed route.

16. The method for transporting cassette as claimed in claim 15, wherein the specific step of transporting the cassette with glass substrates to the crane is:
pre-designing the route of transporting the cassette from the unload port to the crane;
driving the vertical transport mechanism or/and the horizontal transport mechanism to transport the cassette to the crane according to the pre-designed route.
